(19) United States
(12) Patent Application Publication
(10) Pub. No.: US 2010/0165927 A1
(43) Pub. Date: Jul. 1, 2010

(54) METHOD FOR PAGING TERMINAL OF RRC CONNECTED STATE IN LTE SYSTEM

(76) Inventors: Jung-Im Kim, Daejon (KR); Jae-Heung Kim, Daejon (KR); Kyoung-Seok Lee, Daejon (KR); Byung-han Ryu, Daejon (KR)

Correspondence Address: STAAS & HALSEY LLP, SUITE 700, 1201 NEW YORK AVENUE, N.W., WASHINGTON, DC, 20005, US

(21) Appl. No.: 12/305,781

(22) PCT Filed: Jun. 21, 2007
(86) PCT No.: PCT/KR2007/003019

§ 371 Date: Dec. 19, 2008

(30) Foreign Application Priority Data
Jun. 21, 2006 (KR) 10-2006-0055902

(51) Int. Cl. H04W 72/04

(52) U.S. Cl. 370/329

(57) ABSTRACT

Provided are a method and base station for paging terminals in a radio resource control (RRC) connected state in a packet based mobile communication system. The method for paging terminals in a RRC connected state in a packet based mobile communication system having a RRC processor, a medium access control (MAC) processor, and a physical layer processor includes the steps of: a) at a MAC processor of a base station, generating a paging message when it is necessary to page the terminals and transferring the generated paging message to the physical layer processor, b) at the physical layer processor, transmitting a paging indicator having a unique identifier of the terminal to the terminal; and c) transmitting radio resource information to the terminal through a control channel when an acknowledgement for the paging indicator is received from the terminal.

### TECHNICAL FIELD

The present invention relates to a technology for paging terminals in a radio resource control (RRC) connected state in a packet-based next-generation mobile communication system; and, more particularly, to a paging method for lowering the power consumption of a terminal that operates at a discontinuous reception Cycle by enabling a medium access control (MAC) processor of a base station to page terminals in a radio resource control (RRC) connected state using a paging indicator having a unique identifier of a terminal in a long term evolution (LTE) system developed by the 3^{rd} generation partnership project (3GPP).

### BACKGROUND ART

In a 3^{rd} generation partnership project (3GPP) wideband code division multiple access (WCDMA) wireless communication system, a terminal operates based on a circuit switched scheme that allows only a corresponding terminal to use allocated radio resources after the radio resource is allocated to the corresponding terminal for a voice over Internet Protocol (VoIP) service.

In order to complement the shortcomings of a circuit switch based WCDMA system, 3GPP has progressed the standardization of a packet service based long terminal evolution (LTE) system. In other words, 3GPP has gradually changed the circuit switched scheme to the packet switched scheme to overcome the problem of the circuit switched scheme, which is the ineffective use of resources.

A long term evolution (LTE) system is a technology that realizes a high-speed packet based communication, for example, about 100 Mbps. It is expected that the LTE system will be commercialized by the year 2010. An orthogonal frequency division multiplexing access (OFDMA) has been considered to be used for the LTE system. Unlike a code division multiple access (CDMA) that distinguishes radio resources of each terminal by allocating codes, the OFDMA system has two dimensional radio resources distinguished by a frequency and a time. That is, the OFDMA system transmits and receives radio resources constituted of a time and a frequency after the radio resources are divided into an uplink physical channel and a downlink physical channel. Also, the OFDMA system uses radio resource blocks divided by a transmission time interval (TTI) as a transmission period and a sub carrier group. A radio frame forming such radio resources is formed of 0.5 millisecond slots or TTIs. Therefore, one radio frame is formed of 20 slots in case of 10 millisecond wireless frame.

As described above, the packet switched scheme enables a plurality of terminals to share radio resources instead of allocating radio resources to a predetermined terminal. The packet switched scheme more effectively uses radio resources than a circuit switched scheme because the packet switched scheme selects a terminal to allocate a radio resource according to the radio channel state of a terminal, which dynamically changes according to the necessity of data transmission or according to a time.

FIG. 1 is a diagram illustrating a protocol structure in a control plane of a WCDMA system according to the related art.

A wireless interface protocol of a WCDMA mobile communication network includes a physical layer, a data link layer, and a network layer, horizontally. The wireless interface protocol also includes a user plane for transmitting data and a control plane for transmitting a control signal, vertically. The protocol layers may be divided into a first layer L1, a second layer L2, and a third layer L3 based on the lower three layers in an open system interconnection (OSI) model.

The first layer, a physical layer, provides an information transfer service to an upper layer using a physical channel. The physical layer is connected to a medium access control (MAC) layer through a transport channel. Data moves between the MAC layer and the physical layer through the transport channel.

The second layer, a MAC layer, provides a service to a radio link control (RLC) layer through a logical channel. The RLC layer of the second layer supports reliable data transmission. The RLC layer also segments and concatenates RLC service data units (SDU) from the upper layer.

The radio resource control (RRC) layer, the lowest layer among the three layers, is defined only in a control plane. The RRC layer controls the logical channel, the transport channel, and the physical channel related to configuration, re-configuration, and release of radio bearers.

The described protocol structure is identically applied to the LTE system. The present invention will be described with reference to the protocols because the present invention relates to the RRC layer, the MAC layer, and the physical layer.

If the RRC layer allocates a radio resource such as a channel to a terminal, the allocated channel cannot be used by the other terminal in the circuit switch WCDMA system. That is, it is effective to centrally manage the radio resources through the RRC layer in the circuit switch WCDMA system. Therefore, the relation between the terminal and the RRC layer is defined according to which a radio resource channel is used.

As shown in FIG. 2, there may be two modes present between a terminal and a RRC layer, a RRC connected mode and an idle mode. In the idle mode, the RRC layer cannot be aware of the location of a terminal, and the terminal can receive a paging channel and a part of a broadcast channel. The RRC connected mode is divided into a URA_PCH state 102, a Cell_PCH state 101, a Cell_DCH state 103, and a Cell_FACH state 104.

In the Cell_PCH state 101, a RRC layer has information about a cell where a terminal is located, and a terminal can receive a paging channel and a part of a broadcast channel. In the URA_PCH state 102, a RRC layer can be aware of a registration area where a terminal is present, and a terminal can receive a paging channel and a part of a broadcast channel. The registration area is a unit for managing locations of terminals in a system. The registration area is larger than a cell and can include a plurality of cells. In the Cell_FACH state 104, a RRC layer has information about a cell where a terminal is present, a base station transmits data through a forward access channel FACH which is a channel available to use by a plurality of terminals, and a terminal is assigned with a channel to transmit data. In the Cell_DCH state 103, a RRC layer has information about a cell where a terminal is located, and a RRC layer allocates a dedicated channel to a terminal.

In the WCDMA system, the RRC connected mode is divided into a Cell_PCH state 101 and a URA_PCH state 102 in which a terminal cannot transmit and receive data, and a Cell_FACH state 104 and a Cell_DCH state 103 in which a terminal can transmit and receive data and pages. In the WCDMA system, the states of a terminal for MAC were not defined.

In the WCDMA system according to the related art, a RRC layer manages an operation for paging terminals when terminals receive data or when terminals receive system information because the system information changes. The RRC layer divides the paging operation into a first paging type 1 and a second paging type 2 for managing the paging operation.

In the first paging type 1, a terminal cannot transmit and receive data in a RRC disconnected mode or a RRC connected mode, and the first paging type 1 is used in a Cell-PCH state and a URA_PCH state in which a terminal can read a paging channel only. The first paging type 1 uses a paging indicator channel PICH that is a physical layer channel shared by a plurality of terminals, and a secondary common control physical channel (S-CCPCH) that is a paging message channel. The paging indicator is used to group terminals using unique identifiers and to inform one of the grouped terminals that a related paging message is present. The terminal informed of the related paging message through the paging indicator is only allowed to read the related paging message. The paging indicator channel and the paging message change are shared by a plurality of terminals.

In other words, a base station informs terminals in a corresponding group about the existence of a paging message through a paging indicator channel (PICH) which is a physical layer channel. Then, the terminals monitor the PICH at a regular cycle. If the terminal senses corresponding indication information in the PICH according to the monitoring result, the terminal searches PCH information transmitted to a S-CCPCH and modulates paging information including an international mobile subscriber identity (IMSI) as an own ID, a temporary mobile subscriber identity (TMSI), and a UMTS terrestrial radio access network—radio network temporary identifier (U-RNTI). The terminals that demodulate the paging information perform corresponding post processes.

In the first paging type 1, a terminal and a RRC layer of a base station manage the paging process based on agreements previously defined. That is, the base station and the terminal make an agreement for when a paging indicator is transmitted and when a terminal reads. The terminal uses electric power only when the terminal reads the paging indicator. That is, when the terminal does not read the paging indicator, the terminal does not use power. If the paging indicator includes information about a group of a corresponding terminal is paged, the corresponding terminal demodulates and decodes the paging message channel to confirm whether oneself is paged or not.

When a terminal is in a Cell_FACH state and a Cell_DCH state for transmitting and receiving a data channel, the second paging type 2 is used using a dedicated channel of a terminal. In the second paging type 2, a paging operation is performed using the dedicated channel of a terminal without the paging indicator. That is, only a corresponding terminal receives a paging message through the dedicated channel.

A base station, an enhanced Node B (eNB), of a LTE system has a protocol layer shown in FIG. 1 like combination of a Node B of a WCDMA system and radio resource control (RRC). In other words, the eNB is formed of a radio resource control (RRC) layer, a radio link control (RLC) layer, a media access control (MAC) layer, and a physical layer.

In a circuit switched scheme, the RRC layer allocates and releases radio resources. Since the LTE system uses a packet switched scheme, a scheduler of a MAC layer allocates and releases radio resources. That is, in order to effectively adapt the states of wireless channel which change dynamically, the MAC layer manages the allocation and the release of radio resource.

The MAC scheduler of the LTE system allows a plurality of terminals to use a channel for transmitting and receiving data. The MAC scheduler selects terminals according to the states of a wireless channel, a service priority and allocates radio resources. Therefore, terminals to be allocated with radio resources can change in every instance. Due to such reasons, a terminal must receive a control channel that transfers information about how and which radio resource space is transmitted and received in order to perform a data service. The MAC scheduler manages terminals using discontinuous transmission and reception parameters in consideration of effective channel use and power consumption of a terminal. For example, the discontinuous transmission and reception parameters 0, 2, 22, 23, and 24 can be used. Herein, 0 means a state that allows a terminal to continuously transmit and receive data.

The WCDMA system performs a paging operation when data that a terminal must receive is created or when system parameters change. A RRC layer decides parameters such as a discontinuous reception cycle of a paging indicator, and a terminal checks whether oneself is paged or not by reading a paging indicator at the decided discontinuous reception cycle. Herein, the discontinuous reception cycle (DRX cycle) denotes a cycle of reading a paging indicator at a terminal. A terminal receives a predetermined region, periodically.

In the LTE system in a RRC connected state, a scheduler of a MAC layer decides and manages the discontinuous transmission and reception cycle of a terminal according to a service in consideration of effective radio resource usage and power consumption of a terminal. Since the LTE system uses a packet switched scheme, a terminal must be allocated with an available time for using a data service and a radio channel space through a control channel. According to the service, a method of using a control channel may differ.

For example, a control channel may be regularly allocated to a terminal in case of a voice over IP (VoIP) service. For another example, since a data amount and a data arrival time dynamically change in a time domain, it must also dynamically change whether a control channel is allocated to a predetermined terminal or not in case of data services such as ftp and http. A terminal must be always allocated with a control channel because the terminal has no information about when a control channel is allocated. Therefore, a terminal uses the large amount of power to read a control channel that is not allocated to the terminal oneself. Due to such reasons, a discontinuous reception cycle must be properly decided in consideration of a time delay required in a service and a power consumption of a terminal.

### DISCLOSURE

### Technical Problem

An embodiment of the present invention is directed to provide a paging method for lowering the power consumption of a terminal that operates at a discontinuous reception cycle by enabling a medium access control (MAC) processor of a base station to page terminals in a radio resource control (RRC) connected state using a paging indicator having a unique identifier of a terminal in a long term evolution (LTE) system, and a base station therefor.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for paging terminals in a radio resource control (RRC) connected state in a packet based mobile communication system having a radio resource control (RRC) processor, a medium access control (MAC) processor, and a physical layer processor, including the steps of: a) at a MAC processor of a base station, generating a paging message when it is necessary to page the terminals and transferring the generated paging message to the physical layer processor; b) at the physical layer processor, transmitting a paging indicator having a unique identifier of the terminal to the terminal; and c) transmitting radio resource information to the terminal through a control channel when an acknowledgement for the paging indicator is received from the terminal.

According to an embodiment, the paging indicator is transmitted to the terminal without channel encoding.

According to an embodiment, the paging indicator is transferred to the terminal at a predetermined time.

According to an embodiment, when discontinuous reception cycles are identical according to services, the paging indicator is transmitted to the terminal at the discontinuous reception cycle, and the unique identifier of the terminal, included in the paging indicator, is allocated using a scheduling identifier (MACID) (or a C-RNTI) and the discontinuous reception cycle.

In accordance with an aspect of the present invention, there is provided a base station for paging terminals in a radio resource control (RRC) connected state in a packet based mobile communication system, including: a radio resource control (RRC) processing means for controlling a logical channel, a transport channel, and a physical channel related to configuration and release of wireless barriers, and controlling operations for paging terminals in a radios resource control (RRC) idle state; a physical layer processing means for transmitting a radio resource control (RRC) paging message generated by the RRC processing means as a RRC paging indicator including a unique identifier of a terminal and transmitting a medium access control (MAC) paging indicator including a unique identifier of the terminal for a MAC paging message to the terminal; and a MAC processing means for generating the MAC paging message according to the necessity of paging terminal in a radio resource control (RRC) connected state, transferring the generated MAC paging message to the physical layer processing means, and transmitting radio resource information to the terminal through a control channel.

### ADVANTAGEOUS EFFECTS

According to an embodiment of the present invention, terminals in an RRC connected state are paged using unique identifiers. Therefore, the power consumption of a terminal can be lowered because it is not necessary for a terminal to demodulate a control channel.

### BRIEF DESCRIPTION OF THE DRAWINGS

FIG. 1 is a diagram illustrating a protocol structure of a wideband code division multiple access (WCDMA) mobile communication system in accordance with the related art.

FIG. 2 is a state diagram for describing modes according to a RRC connected state of a terminal.

FIG. 3 is a diagram for describing a paging method in accordance with an embodiment of the present invention.

FIG. 4 is a flowchart for describing a multiple access control (MAC) paging method in a base station in accordance with an embodiment of the present invention.

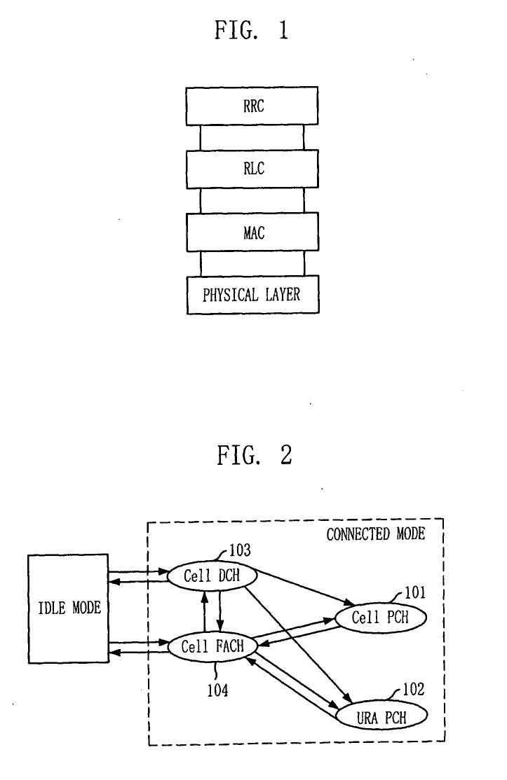

### BEST MODE FOR THE INVENTION

The advantages, features and aspects of the invention will become apparent from the following description of the embodiments with reference to the accompanying drawings, which is set forth hereinafter.

In general, a system informs a terminal of a discontinuous reception cycle and informs a multiple access control (MAC) layer of whether a terminal must receive a paging indicator or not when a terminal starts a service. Also, a system can inform a time of reading a paging indicator for a predetermined service through broadcasting. In case of a voice over IP (VoIP) service, a system allocates a discontinuous reception cycle only to a terminal and it is not necessary to receive a paging indicator because the data amount and the arrival time are almost constant. Therefore, it is difficult to have any benefit from the use of the paging indictor. However, the power consumption of a terminal can be reduced if a paging indicator is used in case of data services such as ftp and http.

It is necessary for a terminal to change a discontinuous reception cycle when a base station creates data transmitted to terminals that operate only at a discontinuous reception cycle. The discontinuous reception cycle can change through following two methods.

In the first method, an indicator is used to inform a terminal to change the discontinuous reception cycle. In the second method, a terminal monitors a control channel at a predetermined time to determine whether it is necessary to change a discontinuous reception cycle or not. The first method is named as a MAC paging method. The MAC paging method is proposed as an embodiment of the present invention.

In the wideband code division multiple access (WCDMA) system according to the related art, a radio resource control (RRC) layer manages paging operations. In the present invention, a RRC layer performs a paging operation for paging terminals in a RRC idle state, and a multiple access control (MAC) layer performs a paging operation for paging terminals that need to change a discontinuous reception cycle among terminals in a MAC discontinuous reception state.

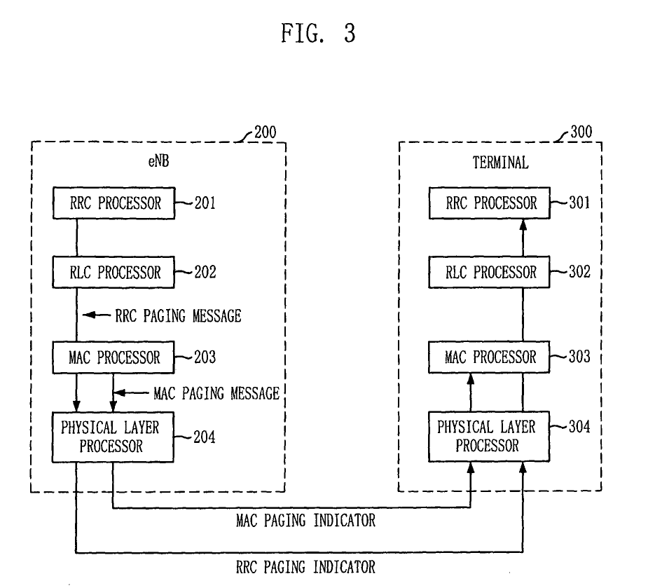

FIG. 3 is a diagram for describing a paging method in accordance with an embodiment of the present invention.

In FIG. 3, a terminal 300 and a base-station 200 (eNB) includes a radio resource control (RRC) layer, a radio link control (RLC) layer, a multiple access control (MAC) layer, and a physical layer. For convenience, a RRC layer is named as a RRC processor 201 or 301, a RLC layer is named as a RLC processor 202 or 302, a MAC layer is named as a MAC processor 203 or 303, and a physical layer is named as a physical layer processor 204 or 304.

As shown in FIG. 3, an evolved node B (eNB) 200, a base station, includes a physical processor 204 as a first layer, a MAC processor 203 as a second layer, and a radio resource control processor 201 as a third layer. Since the radio link control (RLC) layer does not significantly influence the feature of the present invention, the detailed description thereof is omitted.

The RRC processor 201 in the eNB 200 transfers a RRC paging message to a RLC processor 202 and a MAC processor 203 in order to page terminals in a RRC idle state. Then, the physical layer processor 204 transmits a RRC paging indicator having an international mobile subscriber identity (IMSI) to a terminal, where the IMSI is a unique identifier of a terminal to a terminal.

When the MAC processor 203 pages a terminal in a RRC connected state to change a discontinuous reception cycle, the MAC processor 203 transmits a MAC paging message to a physical layer processor 204. Then, the physical layer processor 204 transmits a MAC indicator having a unique terminal identifier to terminals. The physical layer processor 204 may transmit a MAC paging primitive instead of the MAC paging message. When the physical layer processor 204 transmits a MAC paging message, the message is an upper level message to transmit to terminals after a discontinuous reception cycle. When the physical layer processor 204 transmits the MAC paging primitive, the MAC paging primitive informs the physical layer processor 204 of the necessity of the MAC paging from the MAC processor 203.

When the RRC processor manages a paging operation in the LTE system like the WCDMA system according to the related art, the RRC processor can page terminals in a RRC idle state. However, the RRC processor cannot page terminals in a RRC connected state because the RRC processor does not have information about discontinuous transmission and reception cycles decided by a MAC processor. In order to page a terminal in a RRC connected state, the RRC processor must receive information about the discontinuous reception cycle of a terminal from the MAC processor. It is ineffective because the RRC processor receives unnecessary information to page.

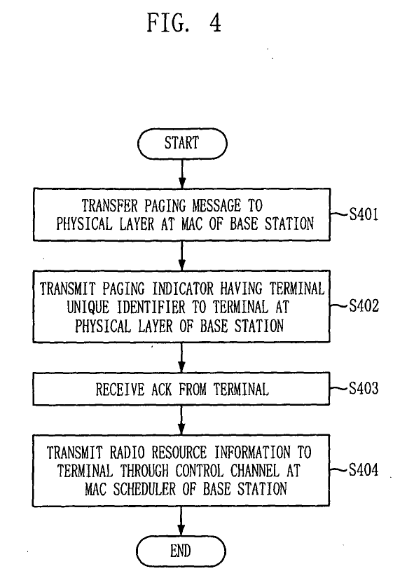

The paging method in accordance with the present embodiment does not need such information. The paging method according to the present embodiment will be described with reference to FIGS. 3 and 4.

If it is necessary to change a discontinuous reception cycle for a terminal in a RRC connected state, the MAC processor 203 of the eNB transmits a MAC paging message to the physical layer processor 204 at step S401. Then, the physical layer processor 204 transmits a paging indicator having a unique identifier of a terminal to the terminal at step S402. The paging indicator is formed not to encode or decode a channel because a terminal may use a large amount of power to encode or decode. The paging indicator is transmitted to a terminal at a predetermined time. The terminal reads a paging indicator from the base station and determines whether oneself is paged or not.

A terminal receiving the paging indicator from the base station acknowledges the receipt of the paging indicator to the MAC processor 203 through the physical layer processor 204 of a base station. An asynchronous random access scheme is used as the acknowledging method.

When the acknowledgement for the paging indicator is received from a terminal at step S403, a scheduler of a MAC processor in a base station transmits radio resource information to a terminal through a control channel at step S404. The radio resource information is about a wireless channel to use. The scheduler is included in a MAC processor 203 of a base station, and a channel encoding is performed on a control channel. In the present embodiment, a terminal in a RRC connected state is informed of being paged using a paging indicator with not channel-encoded, and radio resource information is transferred through a control channel with channel-encoded. Therefore, a terminal does not perform unnecessary decoding operation in the present embodiment.

If the MAC paging is not performed unlike the paging method according to the present embodiment, a terminal can be aware of the necessity of changing a discontinuous reception parameter as follows.

A terminal decodes a control channel at a discontinuous reception cycle and determines the necessity of changing a discontinuous reception cycle based on the result of decoding. At this moment, the terminal uses power to decode the control channel.

Since the terminal cannot frequently decode a control channel because of the power consumption of a terminal, the discontinuous reception cycle cannot be short in this method. If the discontinuous reception cycle is long, a time delay is created to perform a service. Therefore, the discontinuous reception cycle must be decided in consideration of a time delay and power consumption.

This paging method has a disadvantage that a terminal unnecessarily reads a paging indicator continuously and performs a decoding operation although it is not necessary to change the discontinuous reception cycle. On the contrary, since a terminal uses a comparatively smaller amount of electric power to read a paging indicator in the present embodiment, a cycle of reading a paging indicator is set to shorter than a cycle of reading a control channel, thereby reducing the time delay for a service. Therefore, the service quality can be further improved.

The LTE system accepts two possibilities that a terminal is allocated with a cell-radio network temporary identifier (C-RNTI) from a RRC processor of a base station to identify a terminal when a terminal is in a RRC active state and that the terminal may be or may not be allocated with a MACID as a scheduling identifier from the MAC processor. In the present embodiment, a C-RNTI is used as a unique identifier of a terminal included in a paging identifier if the terminal is allocated with only the C-RNTI. When the terminal is allocated with the MACID, the MACID is used as a unique identifier of a terminal included in a paging identifier.

Hereinafter, examples of a paging method according to an embodiment of the present invention will be described. That is, the paging methods will be described when a terminal is allocated with both of the C-RNTI and the MACID, when the discontinuous reception cycle of a terminal is constant regardless of a service that a terminal receives, and when discontinuous reception cycles are decided according to services.

When the discontinuous reception cycle is set differently according to a service of a terminal, a scheduler of a base station decides the discontinuous reception cycle. Then, the MACID is used as a unique identifier of a terminal included in a paging indicator.

The MAC processor of a base station transmits a paging indicator through a physical layer processor according to a decided discontinuous reception cycle when it is necessary to page a terminal to change the discontinuous reception cycle.

The MAC processor of a terminal receives a paging indicator at the discontinuous reception cycle received from the scheduler of the base station. Then, the MAC process confirms whether oneself is paged or not by inspecting whether own ID is present in the received paging indicator or not.

When the discontinuous reception cycle is constant regardless of a service of a terminal, the terminal reads a (L+1+K*n)^{th} paging indicator among times for receiving paging indicators, where MACID % K=L, n−0, 1, 2, 3, 4, 5, . . . , and K is a discontinuous reception cycle. The terminal defines an identifier used by the terminal as MACID/K within a paging indictor without any information received from a base station. The identifier starts from zero.

In other words, if a cell includes 512 terminals in a RRC connected state and the discontinuous reception cycle is 16, there are 512 MACIDs 0 to 511 present. It assumes that a scheduler of a base station allocate a MACID 337 to a terminal. The terminal receives a paging indicator from a base station at once in 16 times as the discontinuous reception cycle. The terminal inspects whether an identifier 21 is included in a paging indicator or not at (2+K*n)^{th} cycle (337% 16=1) whenever the paging indicator is received. The identifier 21 is obtained from the equation MACID/K (337/16=21.0625). The terminal is aware of being paged if the identifier 21 is included in the paging indicator. In A % B, % denotes a modular operation. For example, 3% 4=3, and 61% 3=1. The cycle is allocated in a time domain. 0 is a time of receiving the first paging indicator. If MAC identifier % 16 is 0, the terminal reads a paging indicator at time 0 and do not read a paging indicator at any other times. As described above, a terminal can recognize that own identifier is 21 in a paging indicator although a MAC processor of a base station did not transmit signaling in the present embodiment.

Examples of a paging method according to an embodiment of the present invention will be described. That is, the paging methods will be described when a terminal is allocated only with the C-RNTI, when the discontinuous reception cycle of a terminal is constant regardless of a service that a terminal receives, and when discontinuous reception cycles are decided according to services.

When the discontinuous reception cycle is decided according to a service of a terminal, a scheduler in a base station decides a discontinuous reception cycle, and uses the C-RNTI included in a paging indicator as a unique identifier of a terminal. The terminal determines whether own identifier is included in a paging indicator at every discontinuous reception cycle transferred from a scheduler.

If a discontinuous reception cycle is constant regardless of services, a terminal receives a (L+1+S*n)^{th} paging indicator where S denotes the discontinuous reception cycle and C-RNTI % S=L, n=0, 1, 2, 3, 4, 5, . . . . The terminal defines an own identifier in a paging indicator as C-RNTI/S without any information received from a base station. For example, if a size of C-RNTI is 16 bits, there are 65546 C-RNTIs 0 to 65545. If a discontinuous reception cycle is 16 and if a terminal receives a C-RNTI 1734 from a RRC processor, the terminal reads the (7+S*n)^{th} paging indicator (1734%16=6) at every times of receiving a paging indicator to determines whether own identifier 108 (1734/16=108.375) is included or not.

While the present invention has been described with respect to certain preferred embodiments, it will be apparent to those skilled in the art that various changes and modifications may be made without departing from the spirits and scope of the invention as defined in the following claims.

What is claimed is:

1. A method for paging terminals in a radio resource control (RRC) connected state in a packet based mobile communication system having a radio resource control (RRC) processor, a medium access control (MAC) processor, and a physical layer processor, comprising the steps of:
a) at a MAC processor of a base station, generating a paging message when it is necessary to page the terminals and transferring the generated paging message to the physical layer processor;
b) at the physical layer processor, transmitting a paging indicator having a unique identifier of the terminal to the terminal; and
c) transmitting radio resource information to the terminal through a control channel when an acknowledgement for the paging indicator is received from the terminal.

2. The method of claim 1, wherein the paging message is a paging primitive.

3. The method of claim 1, wherein the paging indicator is transmitted to the terminal without channel encoding.

4. The method of claim 1, wherein in the step c), the acknowledgement for the paging indictor is received through an asynchronous random access scheme.

5. The method of claim 1, wherein the paging indicator is transferred to the terminal at a predetermined time.

6. The method of claim 1, further comprising deciding the discontinuous reception cycle by a scheduler in a MAC processor of the base station when the discontinuous reception cycles differ according to services and transferring the decided discontinuous reception cycle to the terminal,
wherein the paging indicator is transferred to the terminal according to the discontinuous reception cycle.

7. The method of claim 1, wherein the paging indicator is transmitted to the terminal at the discontinuous reception cycle when the discontinuous reception cycles are identical according to services.

8. The method of claim 1, wherein a unique identifier of a terminal, included in the paging indicator, includes a scheduling identifier (MACID).

9. The method of claim 1, wherein the unique identifier of a terminal, included in the paging indicator, includes a C-RNTI allocated by the RRC processor.

10. The method of claim 7, wherein the unique identifier of the terminal, included in the paging indicator, is allocated using the scheduling identifier (MACID) and the discontinuous reception cycle.

11. The method of claim 7, wherein the unique identifier of the terminal, included in the paging indicator, is allocated using a C-RNTI by the RRC processor and the discontinuous reception cycle.

12. A base station for paging terminals in a radio resource control (RRC) connected state in a packet based mobile communication system, comprising:
a radio resource control (RRC) processing means for controlling a logical channel, a transport channel, and a physical channel related to configuration and release of wireless barriers, and controlling operations for paging terminals in a radios resource control (RRC) idle state;
a physical layer processing means for transmitting a radio resource control (RRC) paging message generated by the RRC processing means as a RRC paging indicator including a unique identifier of a terminal and transmitting a medium access control (MAC) paging indicator including a unique identifier of the terminal for a MAC paging message to the terminal; and
a MAC processing means for generating the MAC paging message according to the necessity of paging terminal in a radio resource control (RRC) connected state, transferring the generated MAC paging message to the physical layer processing means, and transmitting radio resource information to the terminal through a control channel.

13. The base station of claim 12, wherein the physical layer processing means transmits the MAC paging indicator to the terminal without a channel encoded.

14. The base station of claim 13, further comprising a scheduler in the MAC processing means for deciding the discontinuous reception cycle,
wherein the MAC paging indicator is transferred to the terminal according to the discontinuous reception cycle.

15. The base station of claim 13, wherein the unique identifier of a terminal having the MAC paging indicator includes a scheduling identifier (MACID).

16. The base station of claim 13, wherein the unique identifier of a terminal having the MAC paging indicator includes a cell-radio network temporary identifier (C-RNTI) that is allocated by the RRC processing means.
